(19) United States
(12) Patent Application Publication
(10) Pub. No.: US 2015/0179142 A1
(43) Pub. Date: Jun. 25, 2015

(54) SYSTEM, METHOD, AND COMPUTER PROGRAM PRODUCT FOR REDUCED-RATE CALCULATION OF LOW-FREQUENCY PIXEL SHADER INTERMEDIATE VALUES

(71) Applicant: NVIDIA Corporation, Santa Clara, CA (US)

(72) Inventors: Jaakko T. Lehtinen, Helsinki (FI); Samuli Matias Laine, Vantaa (FI); Kayvon Fatahalian, Pittsburgh, PA (US); Yong He, Pittsburgh, PA (US); Anjul Patney, Santa Clara, CA (US)

(73) Assignee: NVIDIA Corporation, Santa Clara, CA (US)

(21) Appl. No.: 14/137,888

(22) Filed: Dec. 20, 2013

(51) Int. Cl. G09G 5/10

(52) U.S. Cl. CPC G09G 5/10; G09G 2340/06

(57) ABSTRACT

A system, method, and computer program product are provided for calculating shader program intermediate values. The method includes the steps of receiving a graphics primitive for processing according to a shader program including a first set of instructions and a second set of instructions, executing the first set of instructions by a processing pipeline to calculate multi-pixel intermediate values, executing the second set of instructions by the processing pipeline to calculate per-pixel values based on at least the multi-pixel intermediate values, and repeating the receiving and executing of the first and second sets of instructions for one or more additional graphics primitives.

### FIELD OF THE INVENTION

The present invention relates to graphics processing, and more particularly to calculation of intermediate values by a pixel shader program.

### BACKGROUND

Conventional pixel shader programs compute intermediate values in screen space that are used to determine a final color for each pixel to produce a high-quality image. These intermediate values represent quantities that contribute to the pixel color in a manner specified by the programmer. The intermediate values may be related to surface material and lighting. When anti-aliasing operations are performed, the intermediate values may be computed for multiple samples of each pixel, so that the number of intermediate value computations increases. As the display density increases, the number of intermediate values that are computed to produce an image also increases.

However, some of the intermediate values may only vary by small amounts from pixel to pixel (i.e., the intermediate values are smooth or low-frequency). Therefore, the intermediate values do not necessarily need to be calculated for each sample or for each pixel to produce a high quality image. It is desirable to avoid unnecessary computation of intermediate values. Thus, there is a need for addressing this issue and/or other issues associated with the prior art.

### SUMMARY

A system, method, and computer program product are provided for calculating shader program intermediate values. The method includes the steps of receiving a graphics primitive for processing according to a shader program including a first set of instructions and a second set of instructions, executing the first set of instructions by a processing pipeline to calculate multi-pixel intermediate values, executing the second set of instructions by the processing pipeline to calculate per-pixel values based on at least the multi-pixel intermediate values, and repeating the receiving and executing of the first and second sets of instructions for one or more additional graphics primitives.

### BRIEF DESCRIPTION OF THE DRAWINGS

FIG. 1 illustrates a flowchart of a method for calculating shader program intermediate values, in accordance with one embodiment;

FIG. 2 illustrates a parallel processing unit (PPU), according to one embodiment;

FIG. 3 illustrates the streaming multi-processor of FIG. 2, according to one embodiment;

FIG. 4 is a conceptual diagram of a graphics processing pipeline implemented by the PPU of FIG. 2, in accordance with one embodiment;

FIG. 5 illustrates a PPU that is configured to implement the graphics processing pipeline, in accordance with another embodiment;

FIG. 6 illustrates pseudo code corresponding to a portion of a shader program that is annotated, in accordance with one embodiment:

FIG. 7A illustrates a flowchart of a method for producing shader program instructions for an annotated shader program, in accordance with one embodiment;

FIG. 7B illustrates another flowchart of a method for calculating shader program intermediate values, in accordance with one embodiment; and

FIG. 8 illustrates an exemplary system in which the various architecture and/or functionality of the various previous embodiments may be implemented.

### DETAILED DESCRIPTION

Intermediate values calculated by a pixel shader program that may be calculated at a reduced rate include intermediate values corresponding to attributes related to, including but not limited to far-field ambient occlusion, soft shadows, ambient lighting approximation, procedurally shaded particle billboards, and ray-marching results for volumetric effects. These intermediate values may vary by small amounts from pixel to pixel (i.e., are low-frequency intermediate values) and the final image quality may not be significantly reduced when these intermediate values are calculated at the reduced rate. Instead of calculating the intermediate values for each pixel or for each sample of a pixel, the low-frequency intermediate values may be calculated once for multiple pixels. The low-frequency intermediate values may then be combined with high-frequency values according to the pixel shader program to produce the final image. Efficiency of the pixel shader program in terms of processing speed and power may be improved when the number of intermediate values that are computed per-pixel is reduced.

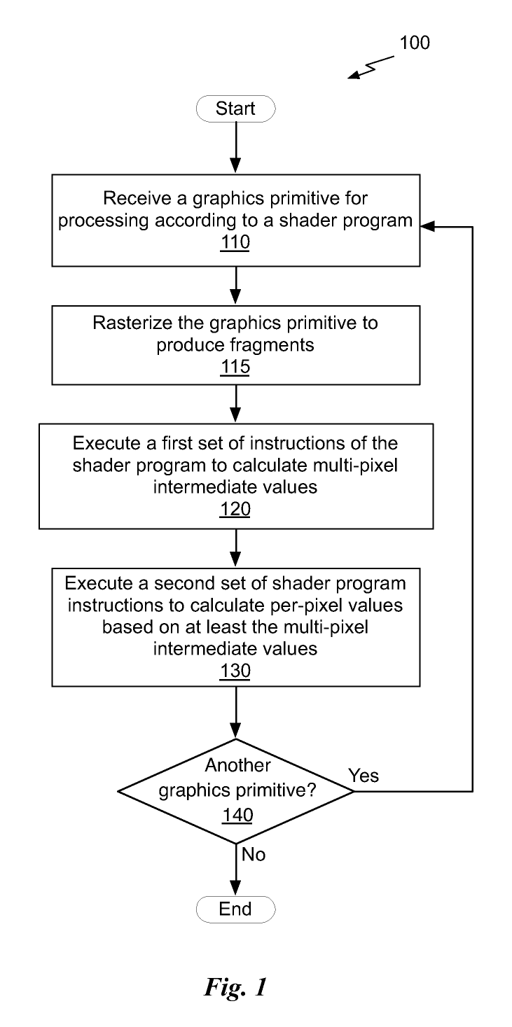

FIG. 1 illustrates a flowchart of a method 100 for calculating shader program intermediate values, in accordance with one embodiment. At step 110, a graphics primitive is received by a processing pipeline. In the context of the present description, the processing pipeline may be a graphics processing pipeline that is implemented by a graphics processor or a general purpose processor, either of which is configured to execute instructions of the shader program. In the context of the present description, a graphics primitive may be a point, line, triangle, polygon, triangle strip, triangle fan, or the like.

At step 115, the graphics primitive is rasterized to produce fragments. The fragments cover at least a portion of one or more pixels. In the context of the following description, the fragments are shaded according to a fragment shader program to produce at least color values for each pixel of an image. One or more attributes may be defined for each fragment, and the attributes are processed by the fragment shader program to produce at least the color values.

The shader program includes at least a first set of instructions and a second set of instructions. At step 120, the first set of instructions is executed by the processing pipeline to calculate multi-pixel intermediate values associated with the fragments. Each multi-pixel value corresponds to two or more pixels. In one embodiment, a multi-pixel corresponds to four pixels, such as a 2×2 pixel “quad”. A different multi-pixel value may be calculated for each pixel attribute, but each value that is calculated is shared between all of the pixels corresponding to the multi-pixel. In the context of the following description pixel attributes include color, texture map coordinates, normal vectors, height fields, vertices, depth, illumination intensity, ambient occlusion, shadow intensity, and the like.

At step 130, the second set of instructions is executed by the processing pipeline to calculate per-pixel values associated with the fragments. In the context of the present description, per-pixel intermediate values may be calculated for at least one location within each pixel and then combined with the multi-pixel intermediate values, according to the shader program, to produce the per-pixel values (e.g., shaded attributes). A different per-pixel value may be calculated for each pixel attribute, but each value that is calculated is associated with one pixel. In other words, the granularity of the values that are calculated for the second set of instructions is finer (i.e., higher) than the granularity of the intermediate values that are calculated for the first set of instructions.

At step 140, the processing pipeline determines if another graphics primitive should be processed, and, if so, the processing pipeline returns to step 110. Otherwise, processing of the graphics primitives is complete and execution of the shader program terminates. The per-pixel values may be output for display after all of the graphics primitives have been processed according to the shader program.

A forward shading process is shown in FIG. 1, where each graphics primitive is completely shaded in sequence (i.e., all of the graphics primitives are processed in single pass through processing pipeline configured to perform the pixel shading operations). In contrast, when a deferred shading process is used, the graphics primitives are processed in multiple passes through a processing pipeline that is configured to perform the pixel shading operations. A different portion of the shading operations may be performed on all of the graphics primitives during each one of the multiple passes and shaded pixel attributes may be stored at the end of one or more passes and processed during one or more subsequent passes. Although the forward shading process is illustrated in FIG. 1, the approach of calculating multi-pixel intermediate values may also be used during a deferred shading process to calculate multi-pixel intermediate values during one or more of the multiple passes.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

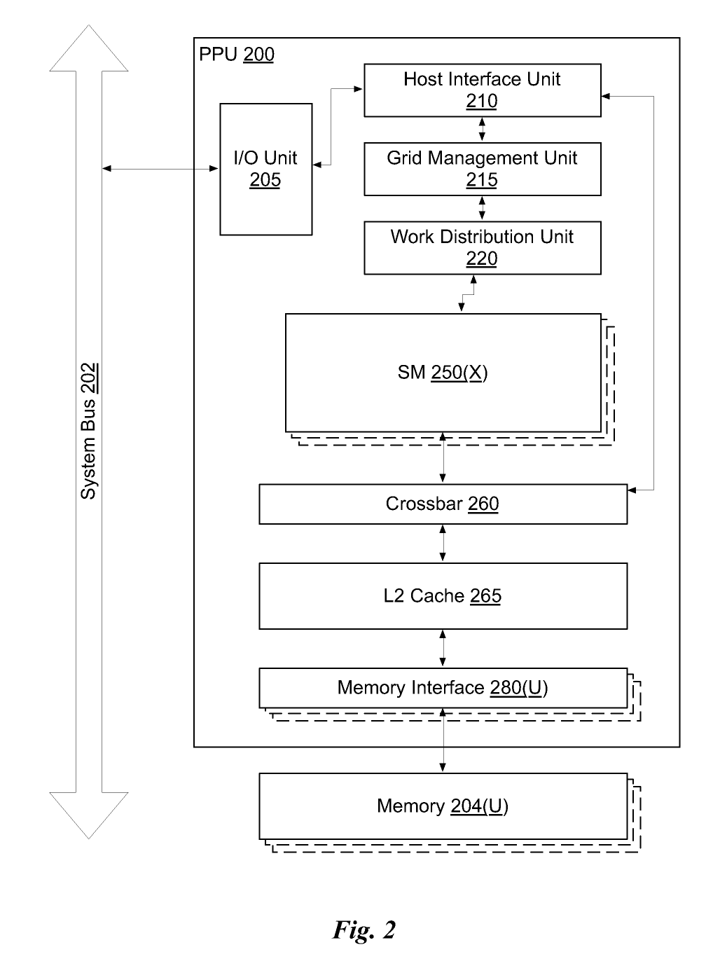

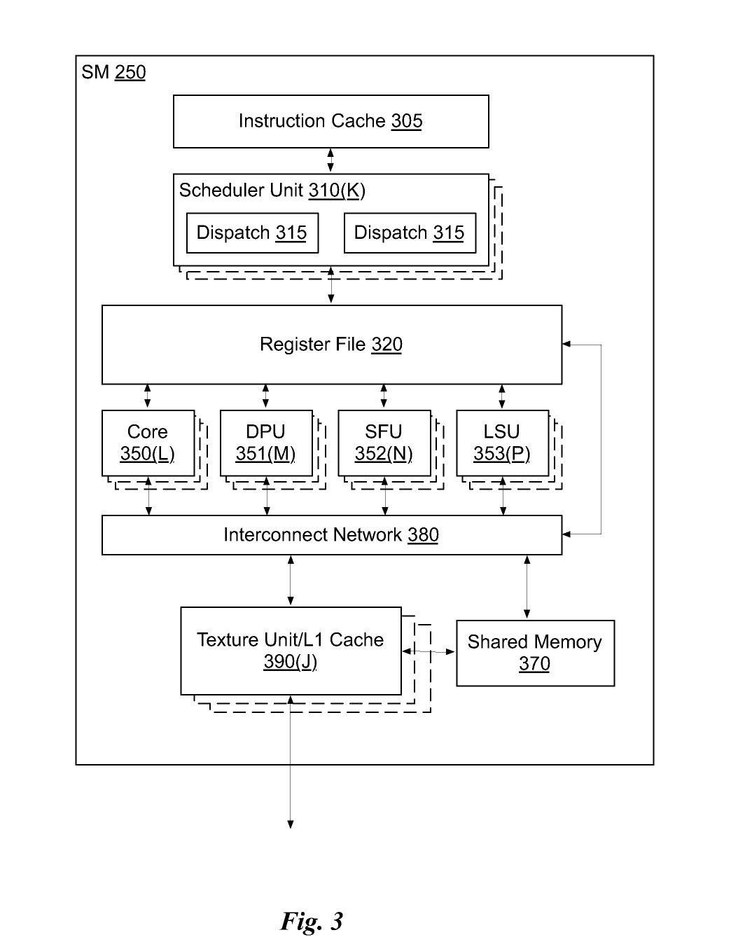

FIG. 2 illustrates a parallel processing unit (PPU) 200, according to one embodiment. While a parallel processor is provided herein as an example of the PPU 200, it should be strongly noted that such processor is set forth for illustrative purposes only, and any processor may be employed to supplement and/or substitute for the same. In one embodiment, the PPU 200 is configured to execute a plurality of threads concurrently in two or more streaming multi-processors (SMs) 250. A thread (i.e., a thread of execution) is an instantiation of a set of instructions executing within a particular SM 250. Each SM 250, described below in more detail in conjunction with FIG. 3, may include, but is not limited to, one or more processing cores, one or more load/store units (LSUs), a level-one (L1) cache, shared memory, and the like.

In one embodiment, the PPU 200 includes an input/output (I/O) unit 205 configured to transmit and receive communications (i.e., commands, data, etc.) from a central processing unit (CPU) (not shown) over the system bus 202. The I/O unit 205 may implement a Peripheral Component Interconnect Express (PCIe) interface for communications over a PCIe bus. In alternative embodiments, the I/O unit 205 may implement other types of well-known bus interfaces.

The PPU 200 also includes a host interface unit 210 that decodes the commands and transmits the commands to the grid management unit 215 or other units of the PPU 200 (e.g., memory interface 280) as the commands may specify. The host interface unit 210 is configured to route communications between and among the various logical units of the PPU 200.

In one embodiment, a program encoded as a command stream is written to a buffer by the CPU. The buffer is a region in memory, e.g., memory 204 or system memory, that is accessible (i.e., read/write) by both the CPU and the PPU 200. The CPU writes the command stream to the buffer and then transmits a pointer to the start of the command stream to the PPU 200. The host interface unit 210 provides the grid management unit (GMU) 215 with pointers to one or more streams. The GMU 215 selects one or more streams and is configured to organize the selected streams as a pool of pending grids. The pool of pending grids may include new grids that have not yet been selected for execution and grids that have been partially executed and have been suspended.

A work distribution unit 220 that is coupled between the GMU 215 and the SMs 250 manages a pool of active grids, selecting and dispatching active grids for execution by the SMs 250. Pending grids are transferred to the active grid pool by the GMU 215 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 220. In addition to receiving grids from the host interface unit 210 and the work distribution unit 220, the GMU 215 also receives grids that are dynamically generated by the SMs 250 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 200. An application may include instructions (i.e., API calls) that cause the driver kernel to generate one or more grids for execution. In one embodiment, the PPU 200 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 200 comprises X SMs 250(X). For example, the PPU 200 may include 15 distinct SMs 250. Each SM 250 is multi-threaded and configured to execute a plurality of threads (e.g., 32 threads) from a particular thread block concurrently. Each of the SMs 250 is connected to a level-two (L2) cache 265 via a crossbar 260 (or other type of interconnect network). The L2 cache 265 is connected to one or more memory interfaces 280. Memory interfaces 280 implement 16, 32, 64, 128-bit data buses, or the like, for high-speed data transfer. In one embodiment, the PPU 200 comprises U memory interfaces 280(U), where each memory interface 280(U) is connected to a corresponding memory device 204(U). For example, PPU 200 may be connected to up to 6 memory devices 204, such as graphics double-data-rate, version 5, synchronous dynamic random access memory (GDDR5 SDRAM).

In one embodiment, the PPU 200 implements a multi-level memory hierarchy. The memory 204 is located off-chip in SDRAM coupled to the PPU 200. Data from the memory 204 may be fetched and stored in the L2 cache 265, which is located on-chip and is shared between the various SMs 250. In one embodiment, each of the SMs 250 also implements an L1 cache. The L1 cache is private memory that is dedicated to a particular SM 250. Each of the L1 caches is coupled to the shared L2 cache 265. Data from the L2 cache 265 may be fetched and stored in each of the L1 caches for processing in the functional units of the SMs 250.

In one embodiment, the PPU 200 comprises a graphics processing unit (GPU). The PPU 200 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. Attributes may include one of more of position, color, surface normal vector, texture coordinates, etc. The PPU 200 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (i.e., a collection of vertices and attributes) to memory. The model data defines each of the objects that may be visible on a display. The application then makes an API call to the driver kernel that requests the model data to be rendered and displayed. The driver kernel reads the model data and writes commands to the buffer to perform one or more operations to process the model data. The commands may encode different shader programs including one or more of a vertex shader, hull shader, geometry shader, pixel shader, etc. For example, the GMU 215 may configure one or more SMs 250 to execute a vertex shader program that processes a number of vertices defined by the model data. In one embodiment, the GMU 215 may configure different SMs 250 to execute different shader programs concurrently. For example, a first subset of SMs 250 may be configured to execute a vertex shader program while a second subset of SMs 250 may be configured to execute a pixel shader program. The first subset of SMs 250 processes vertex data to produce processed vertex data and writes the processed vertex data to the L2 cache 265 and/or the memory 204. After the processed vertex data is rasterized (i.e., transformed from three-dimensional data into two-dimensional data in screen space) to produce fragment data, the second subset of SMs 250 executes a pixel shader to produce processed fragment data, which is then blended with other processed fragment data and written to the frame buffer in memory 204. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 200 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 200 is embodied on a single semiconductor substrate. In another embodiment, the PPU 200 is included in a system-on-a-chip (SoC) along with one or more other logic units such as a reduced instruction set computer (RISC) CPU, a memory management unit (MMU), a digital-to-analog converter (DAC), and the like.

In one embodiment, the PPU 200 may be included on a graphics card that includes one or more memory devices 204 such as GDDR5 SDRAM. The graphics card may be configured to interface with a PCIe slot on a motherboard of a desktop computer that includes, e.g., a northbridge chipset and a southbridge chipset. In yet another embodiment, the PPU 200 may be an integrated graphics processing unit (iGPU) included in the chipset (i.e., Northbridge) of the motherboard.

FIG. 3 illustrates the streaming multi-processor 250 of FIG. 2, according to one embodiment. As shown in FIG. 3, the SM 250 includes an instruction cache 305, one or more scheduler units 310, a register file 320, one or more processing cores 350, one or more double precision units (DPUs) 351, one or more special function units (SFUs) 352, one or more load/store units (LSUs) 353, an interconnect network 380, a shared memory 370, and one or more texture unit/L1 caches 390.

As described above, the work distribution unit 220 dispatches active grids for execution on one or more SMs 250 of the PPU 200. The scheduler unit 310 receives the grids from the work distribution unit 220 and manages instruction scheduling for one or more thread blocks of each active grid. The scheduler unit 310 schedules threads for execution in groups of parallel threads, where each group is called a warp. In one embodiment, each warp includes 32 threads. The scheduler unit 310 may manage a plurality of different thread blocks, allocating the thread blocks to warps for execution and then scheduling instructions from the plurality of different warps on the various functional units (i.e., cores 350, DPUs 351, SFUs 352, and LSUs 353) during each clock cycle.

In one embodiment, each scheduler unit 310 includes one or more instruction dispatch units 315. Each dispatch unit 315 is configured to transmit instructions to one or more of the functional units. In the embodiment shown in FIG. 3, the scheduler unit 310 includes two dispatch units 315 that enable two different instructions from the same warp to be dispatched during each clock cycle. In alternative embodiments, each scheduler unit 310 may include a single dispatch unit 315 or additional dispatch units 315.

Each SM 250 includes a register file 320 that provides a set of registers for the functional units of the SM 250. In one embodiment, the register file 320 is divided between each of the functional units such that each functional unit is allocated a dedicated portion of the register file 320. In another embodiment, the register file 320 is divided between the different warps being executed by the SM 250. The register file 320 provides temporary storage for operands connected to the data paths of the functional units.

Each SM 250 comprises L processing cores 350. In one embodiment, the SM 250 includes a large number (e.g., 192, etc.) of distinct processing cores 350. Each core 350 is a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 250 also comprises M DPUs 351 that implement double-precision floating point arithmetic, N SFUs 352 that perform special functions (e.g., copy rectangle, pixel blending operations, and the like), and P LSUs 353 that implement load and store operations between the shared memory 370 and the register file 320 via the J texture unit/L1 caches 390 and the interconnect network 380. The J texture unit/L1 caches 390 are coupled between the interconnect network 380 and the shared memory 370 and are also coupled to the crossbar 260. In one embodiment, the SM 250 includes 64 DPUs 351, 32 SFUs 352, and 32 LSUs 353. In another embodiment, the L1 cache is not included within the texture unit and is instead included with the shared memory 370 with a separate direct connection to the crossbar 260.

Each SM 250 includes an interconnect network 380 that connects each of the functional units to the register file 320 and to the shared memory 370 through the interconnect network 380. In one embodiment, the interconnect network 380 is a crossbar that can be configured to connect any of the functional units to any of the registers in the register file 320, to any of the J texture unit/L1 caches 390, or the memory locations in shared memory 370.

In one embodiment, the SM 250 is implemented within a GPU. In such an embodiment, the SM 250 comprises J texture unit/L1 caches 390. The texture unit/L1 caches 390 are configured to access texture maps (i.e., a 2D array of texels) from the memory 204 and sample the texture maps to produce sampled texture values for use in shader programs. The texture unit/L1 caches 390 implement texture operations such as anti-aliasing operations using mip-maps (i.e., texture maps of varying levels of detail). In one embodiment, the SM 250 includes 16 texture unit/L1 caches 390. As described further herein, the texture unit/L1 caches 390 are also configured to receive load and store requests from the LSUs 353 and to coalesce the texture accesses and the load and store requests to generate coalesced memory operations that are output to a memory system that includes the shared memory 370. The memory system may also include the L2 cache 265, memory 204, and a system memory (not shown).

The PPU 200 described above may be configured to perform highly parallel computations much faster than conventional CPUs. Parallel computing has advantages in graphics processing, data compression, biometrics, stream processing algorithms, and the like.

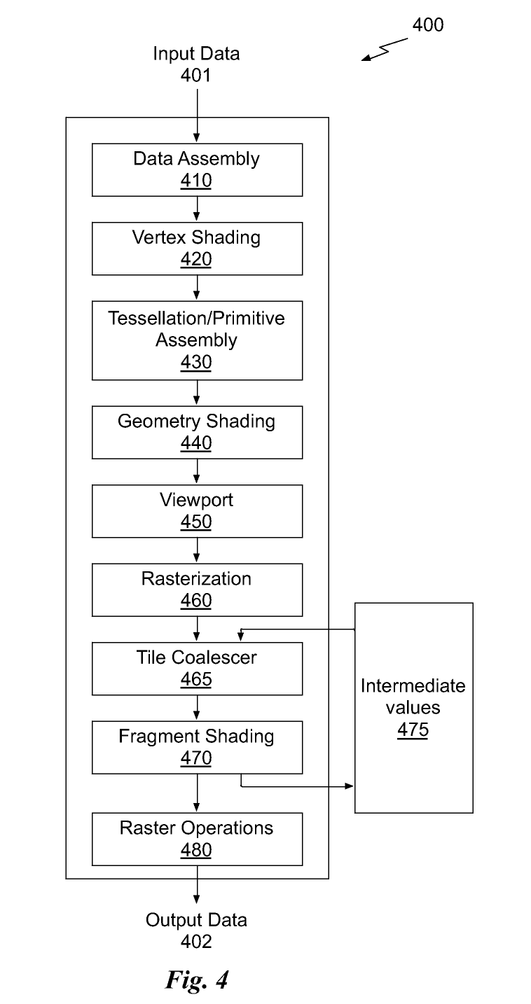

FIG. 4 is a conceptual diagram of a graphics processing pipeline 400 implemented by the PPU 200 of FIG. 2, in accordance with one embodiment. The graphics processing pipeline 400 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 400 receives input data 401 that is transmitted from one stage to the next stage of the graphics processing pipeline 400 to generate output data 402. In one embodiment, the graphics processing pipeline 400 may represent a graphics processing pipeline defined by the OpenGL® API or by DirectX 11® by MICROSOFT.

As shown in FIG. 4, the graphics processing pipeline 400 comprises a pipeline architecture that includes a number of stages. The stages include, but are not limited to, a data assembly stage 410, a vertex shading stage 420, a tessellation/primitive assembly stage 430, a geometry shading stage 440, a viewport transform stage 450, a rasterization stage 460, a fragment shading stage 470, and a raster operations stage 480. In one embodiment, the input data 401 comprises commands that configure the processing units to implement the stages of the graphics processing pipeline 400 and process high-order geometric primitives (e.g., patches) and simpler geometric primitives (e.g., points, lines, triangles, quads, triangle strips or fans, etc.) to be processed by the stages. The output data 402 may comprise pixel data (i.e., color data) that is written into a frame buffer or other type of surface data structure in a memory. The SMs 250 may be configured by shader program instructions to function as one or more shading stages (e.g., vertex, hull, domain, geometry, and pixel shading stages) and write pixel data to the memory 204.

The data assembly stage 410 receives the input data 401 that specifies vertex data for high-order geometry. The data assembly stage 410 collects the vertex data defining the high-order graphics geometry in a temporary storage or queue, such as by receiving a command from the host processor that includes a pointer to a buffer in memory and reading the vertex data from the buffer. In one embodiment, a memory system may include one or more of the memory 204, the L2 cache 265, and the texture unit/L1 cache 390. The vertex data is then transmitted to the vertex shading stage 420 for processing.

The vertex shading stage 420 processes vertex data by performing a set of operations (i.e., a vertex shader or a program) once for each of the vertices. Vertices may be, e.g., specified as a 4-coordinate vector associated with one or more vertex attributes. The vertex shading stage 420 may manipulate properties such as position, color, texture coordinates, and the like. In other words, the vertex shading stage 420 performs operations on the vertex coordinates or other vertex attributes associated with a vertex. Such operations commonly including lighting operations (i.e., modifying color attributes for a vertex) and transformation operations (i.e., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading stage 420 generates transformed vertex data that is transmitted to the tessellation/primitive assembly stage 430.

The tessellation/primitive assembly stage 430 collects vertices output by the vertex shading stage 420 and tessellates patches represented by the vertices and control points into geometric primitives. In one embodiment, the tessellation/primitive assembly stage 430 groups the vertices into geometric primitives for processing by the geometry shading stage 440. For example, the tessellation/primitive assembly stage 430 may be configured to group every three consecutive vertices as a geometric primitive (i.e., a triangle) for transmission to the geometry shading stage 440. In some embodiments, specific vertices may be reused for consecutive geometric primitives (e.g., two consecutive triangles in a triangle strip may share two vertices). The primitive assembly stage 430 transmits geometric primitives (i.e., a collection of associated vertices) to the geometry shading stage 440.

The geometry shading stage 440 processes geometric primitives by performing a set of operations (i.e., a geometry shader or program) on the geometric primitives. Geometry shading operations may generate one or more geometric primitives from each geometric primitive. In other words, the geometry shading stage 440 may subdivide each geometric primitive into a finer mesh of two or more geometric primitives for processing by the rest of the graphics processing pipeline 400. The geometry shading stage 440 transmits geometric primitives to the viewport stage 450.

The viewport stage 450 performs a viewport transform, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (i.e., discarded) because the geometric primitive will not contribute to the final rendered scene. Any geometric primitive that is partially inside the viewing frustum and partially outside the viewing frustum may be clipped (i.e., transformed into a new geometric primitive that is enclosed within the viewing frustum. Furthermore, geometric primitives may each be scaled based on depth of the viewing frustum. All potentially visible geometric primitives are then transmitted to the rasterization stage 460.

The rasterization stage 460 converts the 3D geometric primitives into 2D fragments. The rasterization stage 460 may be configured to utilize the vertices of the geometric primitives to setup a set of surface equations from which various attributes can be interpolated. In one embodiment, the surface equations are plane equations in the form Ax+By+C, where x and y are sample locations and A, B, and C are plane equation parameters. In other embodiments, a surface equation specifies a high-order surface such as a patch. The rasterization stage 460 may also compute a coverage mask for a plurality of pixels that indicates whether one or more sample locations for the plurality of pixels intersect the geometric primitive.

The rasterization stage 460 may be configured to perform early z-testing based on per-vertex depth values to remove geometric primitives that will not be visible. The rasterization stage 460 transmits fragment data including the coverage masks and interpolated per-vertex attributes to a tile coalescer stage 465. The tile coalescer stage 465 gathers a tile of covered pixels for processing by a warp of threads. When the fragment shading stage 470 will calculate per-pixel values, the tile coalescer stage 465 is configured to gather a tile of pixels. When the fragment shading stage 470 will calculate multi-pixel intermediate values, the tile coalesce stage 465 is configured to gather a tile of multi-pixels. Therefore, if each multi-pixel corresponds to a 2×2 pixel region that includes 4 pixels, a tile of multi-pixels will include 4 times as many pixels as when the fragment shading stage 470 will calculate per-pixel values.

In one embodiment, a tile is configured to be processed by a warp of threads, so that an equal number of threads will be allocated to process a tile regardless of whether the fragment shading stage 470 will calculate a value for each sample of a pixel, for each pixel, or for each multi-pixel. Note, that it is not necessary for all of the pixels or multi-pixels in a tile to be covered by a fragment. The tile coalescer stage 465 is configured to output each tile to the fragment shading stage 470.

The fragment shading stage 470 processes fragment data by performing a set of operations (i.e., a fragment shader or a program) on each of the fragments. The fragment shading stage 470 may generate shaded fragment data (i.e., intermediate values 475 or shaded attributes such as color values) for the fragment such as by performing lighting operations or sampling texture maps using interpolated texture coordinates for the fragment. The shaded fragment data may be per-sample shaded attributes where a shaded attribute value is computed for each sample location within a pixel or per-pixel shaded attributes where one or more samples within a pixel share the same computed shaded attribute value. The shaded fragment data may also be per-multi-pixel shaded attributes where multiple pixels share the same computed shaded attribute value. Intermediate values 475 that are calculated for each multi-pixel are stored in the register file 320, shared memory 370, or memory 204, and used by the fragment shading stage 470 to calculate per-pixel shaded attribute values. The fragment shading stage 470 generates per-sample shaded fragment data that is transmitted to the raster operations stage 480. The fragment shading stage 470 may be configured to perform steps 120, 130, and 140 of the method shown in FIG. 1.

The raster operations stage 480 may perform various operations on the shaded fragment data such as performing alpha tests, Z-test, stencil tests, and blending the shaded fragment data with other pixel data corresponding to other fragments associated with the pixel. When the raster operations stage 480 has finished processing the shaded fragment data to produce pixel data (i.e., the output data 402), the pixel data may be written to a display surface (i.e., render target such as a frame buffer, a color buffer, Z-buffer, or the like). The raster operations stage 480 may perform per-sample z-testing so that visible fragment data is written to the frame buffer and obscured fragment data is not written to the frame buffer.

It will be appreciated that one or more additional stages may be included in the graphics processing pipeline 400 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 440). Other types of graphics processing pipelines are contemplated as being within the scope of the present disclosure. Furthermore, any of the stages of the graphics processing pipeline 400 may be implemented by one or more dedicated hardware units within a graphics processor such as PPU 200. Other stages of the graphics processing pipeline 400 may be implemented by programmable hardware units such as the SM 250 of the PPU 200.

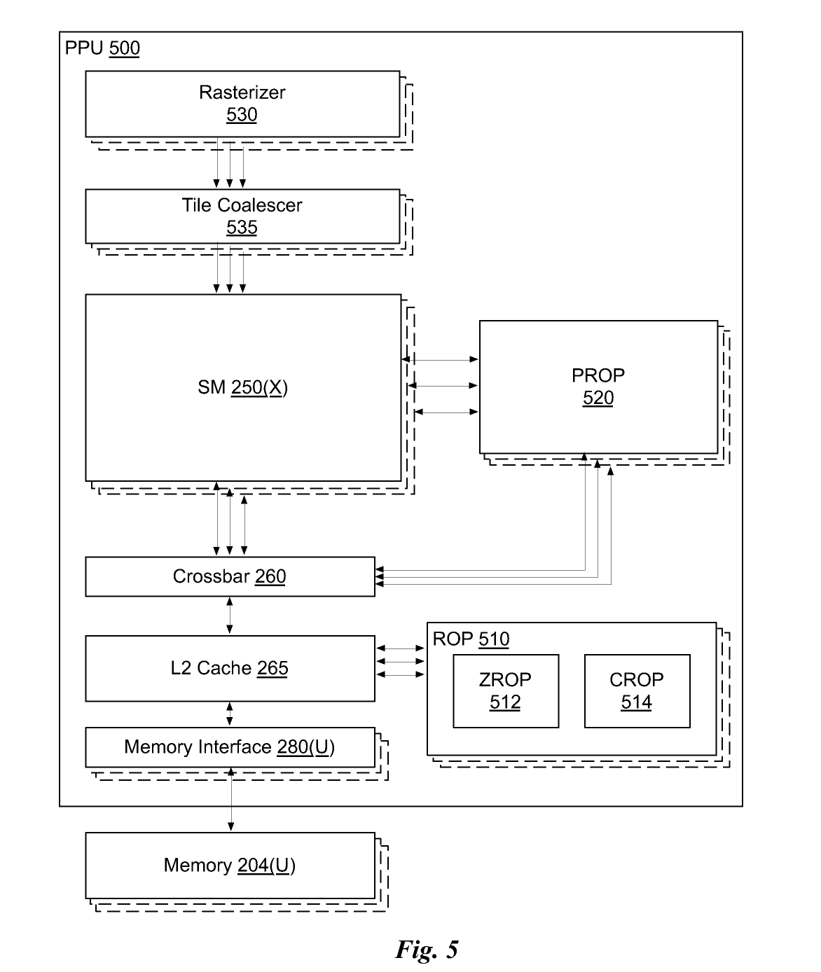

FIG. 5 illustrates a PPU 500 that is configured to implement the graphics processing pipeline 400, in accordance with another embodiment. The PPU 500 is similar to PPU 200 of FIG. 2. The PPU 500 may include one or more dedicated hardware units for implementing various stages of the graphics processing pipeline 400 while other stages of the graphics processing pipeline 400 may be implemented within the programmable SMs 250. As shown in FIG. 5, the PPU 500 includes one or more raster operations units 510, one or more pre-raster operations (PROP) units 520, one or more rasterizers 530 and one or more tile coalescers 535. Each of these dedicated hardware units may be configured to implement at least a portion of the operations for a stage of the graphics processing pipeline 400, described above.

The tile coalescer 535 gathers fragments output by the rasterizer 530 to be processed, and when a tile corresponding to a warp of threads is gathered, the tile is output to an SM 250. Based on the shader program instructions to be executed, the tile may be a tile of multi-pixels or a tile of pixels. In other words, a tile includes a plurality of pixels that may be associated with intermediate values calculated for multiple samples within a pixel, a single sample for each pixel, or multiple pixels of the tile (i.e., a multi-pixel). As used herein, a tile of multi-pixels is a two-dimensional array of pixels including one or more multi-pixels.

When an SM 250 receives fragments for a tile of multi-pixels (i.e., a tile where each intermediate value is calculated for multiple pixels, each processing thread in a first set of processing threads (i.e., a warp) is assigned to calculate one multi-pixel intermediate value for the tile. The multi-pixel intermediate values that are calculated are stored as the intermediate values 475. After the multi-pixel intermediate values 475 corresponding to the fragments of a graphics primitive are stored, the tile coalesce 535 proceeds to gather a tile for executing the second set of instructions. In some embodiments, a multi-pixel hierarchy is used so that a first set of instructions is executed where each intermediate value is shared for 16 pixels (e.g., a 16 pixel multi-pixel), a second set of instructions is executed where each intermediate value is shared for 4 pixels (e.g., a 4 pixel multi-pixel), and then a third set of instructions is executed where each value is calculated for a single pixel (or a sample of a pixel).

When all of the fragments for which multi-pixel intermediate values will be calculated have been dispatched to the SM 250, the tile coalescer 535 can begin to gather the same fragments to a tile of pixels to be processed based on the intermediate values 475. An SM 250 that receives the fragments for the tile of pixels will process the fragments to generate per-pixel values. Each processing thread in a second set of processing threads (i.e., a warp) is assigned to calculate one per-pixel value. One or more of the threads in the first set of processing threads may be included in the second set of processing threads or the second set of processing threads may include different threads. Therefore, one warp with the first set of threads may be launched to process fragments for a tile of multi-pixels and N warps with the second set of threads may be launched to process fragments for a tile of pixels, where N is the number of pixels included in a multi-pixel. The SM 250 may be configured to allocate space in the register file 320 or the shared memory 370 to store the intermediate values 475 and deallocate the space when the intermediate values 475 are no longer needed.

In some cases, the shader program may be configured to cull fragments (i.e., one or more portions of the graphics primitive) corresponding to multi-pixels based on the calculated intermediate values 475. For example, the intermediate values 475 may represent alpha values read from a texture map. If one of the intermediate values 475 for a particular multi-pixel is a transparent alpha value, then the fragments covering pixels included in the particular multi-pixel may be culled. Culling fragments based on the calculated intermediate values 475 reduces the per-pixel calculations that are performed based on the intermediate values 475. For example, 128 fragments are received for a graphics primitive and the 128 fragments are associated with 128 pixels. Assuming that each multi-pixel includes 4 pixels, 32 processing threads may be configured to calculate 32 intermediate values corresponding to 32 multi-pixels. Then, fragments corresponding to 10 of the 32 multi-pixels are culled. The culled fragments correspond to 40 pixels. Therefore, only 88 fragments need to be processed to calculate per-pixel values instead of 128 fragments. The number of warps needed to process the fragments to calculate the per-pixel values is reduced from 4 to 3 (assuming 32 threads per warp).

In addition to the ROP units 510 and the PROP units 520, the PPU 500 includes one or more rasterizers 530 coupled to the one or more SMs 250 via the tile coalescers 535. In one embodiment, the number of rasterizers 530 and the number of tile coalescers 535 equals the number of SMs 250. Each rasterizer 530 is a dedicated hardware unit configured to perform at least a portion of the operations of the rasterization stage 460 of the graphics processing pipeline 400, described above. For example, the rasterizer 530 may receive a geometric primitive from the viewport stage 450 and set up surface equations corresponding to the geometric primitive. Although not explicitly shown, the rasterizers 530 may be coupled to the crossbar 260 in order to communicate with other units of the PPU 500 such as the SMs 250 or a hardware unit configured to implement at least a portion of the operations of the viewport stage 450 of the graphics processing pipeline 400. The tile coalescers 535 are configured to perform at least a portion of the operations of the tile coalescer stage 465 of the graphics processing pipeline 400, described above.

The PROP units 520 retrieve pixel data (e.g., per-pixel values) that is stored in the SM 250 for a pixel set. The pixel set may correspond to a pixel tile, the pixels processed by a warp, or a combination of two or more pixels. The pixel data may be stored in the register file 320 or shared memory 370. In one embodiment, the raster operations (ROP) units 510 include a z-raster operations (ZROP) engine 512 and a color-raster operations (CROP) engine 514. The PROP units 520 manage the flow of pixel data between the ZROP engine 512, the CROP engine 514, and the SM 250. In one embodiment, the number of PROP units 520 matches the number of SMs 250, with each PROP unit 520 allocated to a particular SM 250. It will be appreciated that the number of PROP units 520 is not necessarily the same as the number of ROP units 510.

The ZROP engine 512 compares Z-values for pixel data to previously stored Z-values read for the corresponding sample locations, where the previously stored Z-values are read from a surface (i.e., buffer) stored in the memory 204. The results from the ZROP engine 512 determine if the various pixel data for a fragment will be kept or discarded. More specifically, the ZROP engine 512 compares the Z-value of each sample location with the Z-value of a corresponding sample location stored in a depth map (i.e., Z-buffer surface). This process is known as Z-testing. If the current fragment passes Z-testing, then the ZROP engine 512 optionally writes the Z-value for the current fragment to the corresponding sample location in the depth map. If the current fragment does not pass Z-testing, then the pixel data may be discarded and the Z-value for the current fragment is not written to the depth map. The CROP engine 514 writes the color value for the current fragment to the frame buffer if the fragment passes the Z-testing.

In one embodiment, the number of ROP units 510 may be equal to the number of memory partitions 204, with each ROP unit 510 allocated to a particular memory partition 204. The ZROP unit 512 or the CROP unit 514 reads or writes values to the L2 cache 265. Then, the L2 cache 265 manages memory fetch requests from the memory 204 or the write-back of dirty data from the L2 cache 265 into the memory 204. Although not explicitly shown, the ROP units 510 may be coupled to the L2 Cache 265 as well as the SM 250 and the PROP units 520 via the crossbar 260.

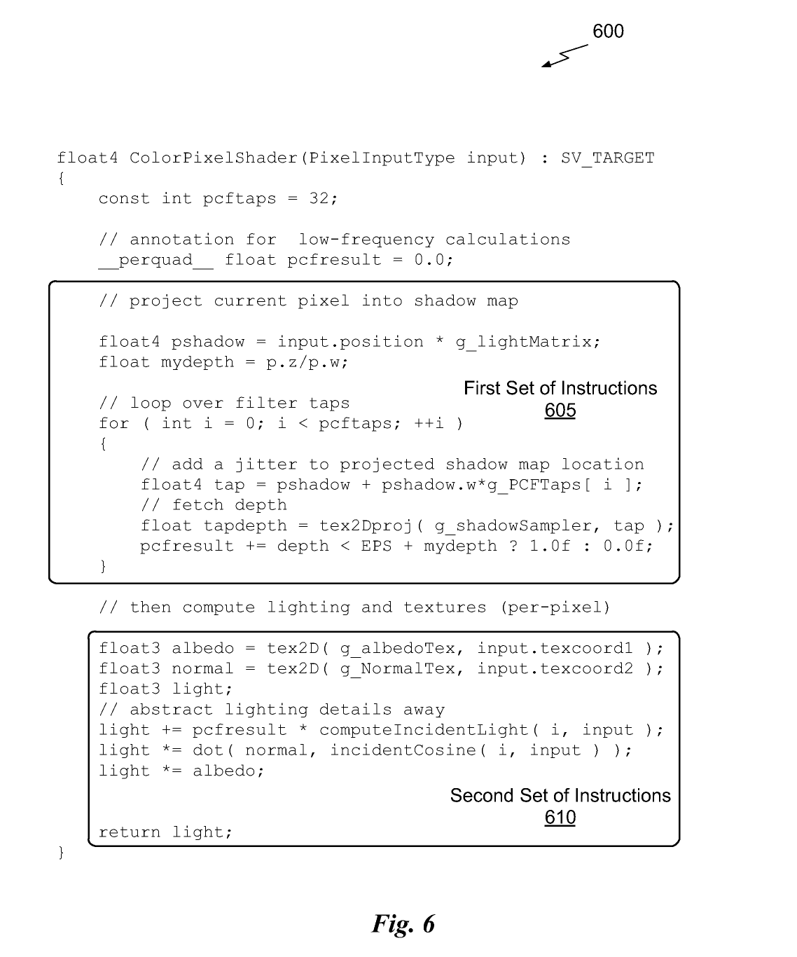

FIG. 6 illustrates pseudo code 600 corresponding to a portion of a shader program that is annotated, in accordance with one embodiment. An author of the shader program determines which intermediate values 475 are to be calculated for multi-pixels instead of for pixels and annotates the shader program using a language construct. For example, the addition of a high-frequency texture to calculate the per-pixel values may mask any apparent blockiness of intermediate values that are calculated at a reduced rate (per the author's annotations). As shown in the pseudo code 600, the qualifier “_perquad_” annotates a portion of the pseudo code 600. The annotation may be specific to a particular hardware platform so that for other platforms, the annotation may be ignored and the intermediate values 475 would be calculated for each pixel instead of for each multi-pixel.

The pseudo code 600 is configured to perform percentage covered filtering for shadows and perform simple lighting, normal mapping, and albedo texturing operations. The pseudo code 600 is an example of a shader and other shader programs that perform other operations may also be annotated and compiled in a similar manner. A live variable analysis shows that computation involving the variables pshadow, mydepth, tap, and tapdepth, to generate the intermediate values of pc f result can be performed at multi-pixel granularity, whereas the remaining variables need to be performed for each pixel. The only data passed between a first set of instructions 605 and a second set of instructions 610 is the variable pcfresult.

A shader compiler that splits the pseudo code 600 into the first set of instructions 605 and the second set of instructions 610 may perform live variable analysis, and determine which values need to be passed between the different sets of instructions. The first set of instructions 605 approximates soft shadows by calculating the intermediate value, pcfresult, for each multi-pixel. The second set of instructions 610 receives the per-multi-pixel pcfresult and calculates a per-pixel color value (albedo), a per-pixel orientation (normal), and finally a per-pixel light value.

The shader compiler may perform the analysis and splitting on existing shader programs that can be annotated to improve processing efficiency. Because per-pixel values are executed by the second set of instructions 610, the results that are generated by the SM 250 and provided to PROP 520 are consistent with the pixel data generated by the existing shader programs. Therefore, reduced-rate calculations may also be combined with functionality such as antialiasing. Specifically, if the shader program specifies that multi-pixel values are to be used directly as final per-pixel values, a set of per-pixel instructions may be generated by the shader compiler to forward the per-multi-pixel values as final shading results. At a language level, compatibility may be enforced by not allowing writes to the shader result variables by instructions that calculate per-multi-pixel intermediate values. Alternatively, the shader compiler may retarget such writes into automatically generated variables and generate instructions to perform the actual writes to the shader result variables as writes to per-pixel values. Yet alternatively, the PROP 520 may be extended to accept multi-pixel values as input.

In one embodiment, the rasterizer 530 generates a fragment for each tile of pixels or a fragment for each pixel. Assuming that a first set of instructions are to be executed to calculate intermediate values 475 for multi-pixels, the tile coalescer 535 is configured to gather a multi-pixel tile instead of a pixel tile and that causes the SM 250 to calculate per-multi-pixel intermediate values 475 for the fragments. Subsequently, the tile coalescer 535 gathers a pixel tile from the multi-pixel intermediate values 475 and causes the SM 250 to calculate per-pixel values for the fragments, as would ordinarily be done to process fragments. However, the second set of instructions also read the intermediate values 475 to process the fragments.

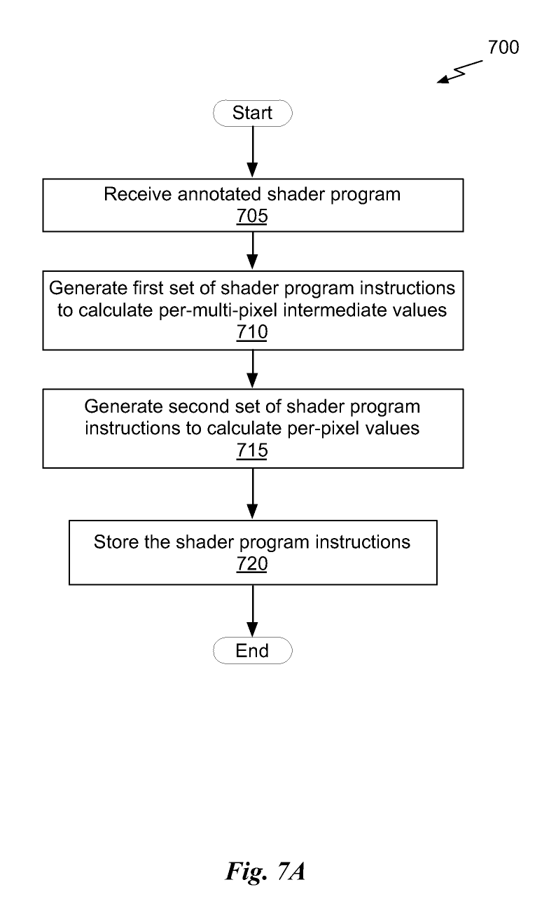

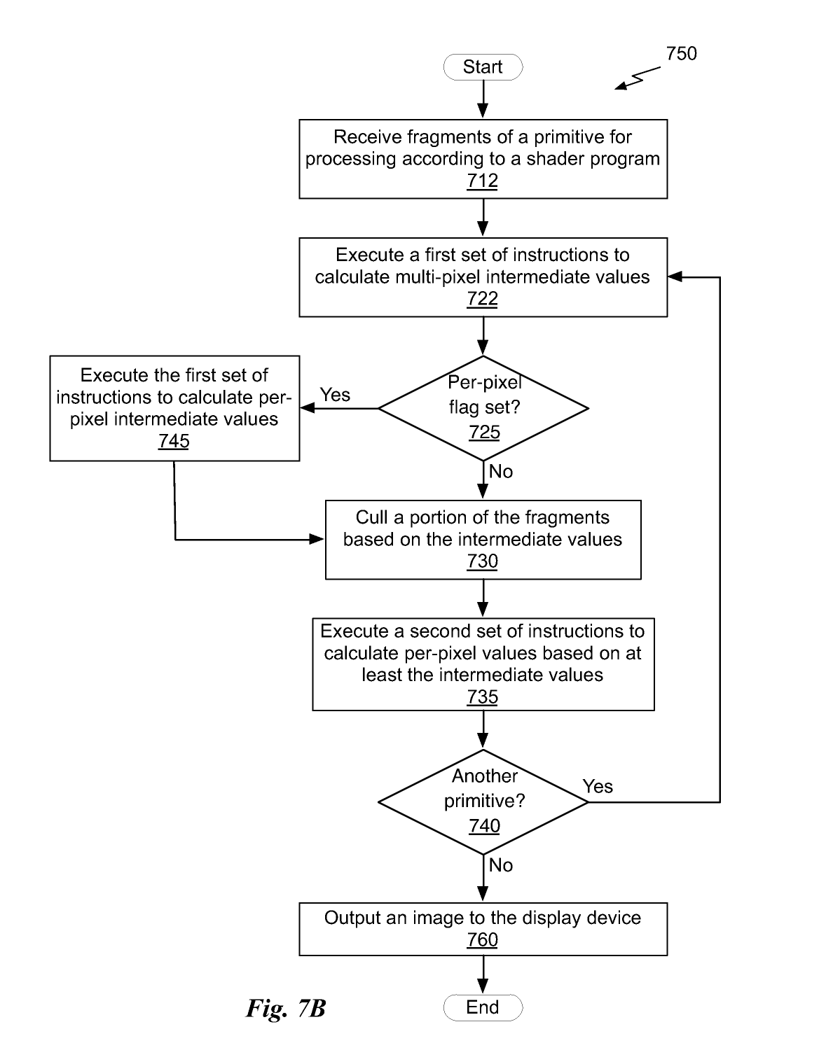

FIG. 7A illustrates a flowchart of a method 700 for producing shader program instructions for an annotated shader program, in accordance with one embodiment. The steps shown in FIG. 7A may be performed by a shader compiler. At step 705, the shader compiler receives an annotated shader program. At step 710, the shader compiler generates a first set of shader program instructions that are configured to calculate per-multi-pixel intermediate values 475 (e.g., the first set of instructions 605). At step 715, the shader compiler generates a second set of shader program instructions that are configured to calculate per-pixel values 475 (e.g., the second set of instructions 610). At step 720, the shader compiler stores the shader program instructions.

At times, the author of the shader program might want to opportunistically try computing certain intermediate values per-multi-pixel without knowing whether the intermediate values are low-frequency. If it turns out that the intermediate values are not low-frequency, then the shader program may be configured to set a flag in the set of instructions that calculates the per-multi-pixel intermediate values and thereby trigger per-pixel calculation of the intermediate values in the set of instructions that calculates the per-pixel values. The SM 250 may be configured to terminate execution of a warp if a flag becomes set during calculation of any of the per-multi-pixel intermediate values. The SM 250 may then set a flag associated with each of the fragments for which a thread was terminated. Terminating execution of a warp minimizes that execution of two code paths to compute the intermediate values.

As the pixel density of the display device which will display an image generated by the shader program increases, the tolerance for error in the intermediate values may increase. For example, when an image that is 740×480 pixels is displayed on a small display, the pixel density is higher than when the same image is displayed on a large display. A display for a mobile device may have physically very dense (small) pixels, so that the tolerable error in the intermediate values is higher compared with a desktop display that has less dense (larger) pixels. Therefore, the author of a shader program may configure the shader program to calculate some intermediate values at a reduced rate (i.e., for multi-pixels) when the pixel density of the display is above a threshold density value. In one embodiment, a number of pixels corresponding to each multi-pixel intermediate value may be determined based on a pixel density of a display device.

FIG. 7B illustrates another flowchart of a method 750 for calculating shader program intermediate values, in accordance with one embodiment. Although the method 750 is described in the context of the SM 250, the method 750 may also be performed by a program, custom circuitry, or by a combination of custom circuitry and a program. At step 712, fragments of a graphics primitive are received by an SM 250. At step 722, a first set of instructions 605 is executed by the SM 250 to calculate multi-pixel intermediate values for the fragments.

At step 725, the SM 250 determines if a per-pixel flag is set by any of the threads executing the first set of instructions. In one embodiment, a per-pixel flag is set to indicate that the intermediate values 475 should be calculated for each pixel instead of for each multi-pixel and the SM 250 terminates execution of a warp when a flag is set for at least one of the threads in the warp. If, at step 725, the SM 250 determines that a per-pixel flag is set, then at step 745, the SM 250 terminates the warp that includes the thread and executes the first set of instructions to calculate per-pixel intermediate values 475 for the fragments (instead of calculating per-multi-pixel intermediate values) before proceeding to step 730. In another embodiment, the SM 250 does not terminate the entire warp but only the individual threads that have the per-pixel flag set. If, at step 725, the SM 250 determines that a per-pixel flag is not set, then the SM 250 calculates the intermediate values 475 for each multi-pixel and then proceeds directly to step 730.

At step 730, the SM 250 may cull a portion of the fragments based on the intermediate values 475 before proceeding to step 735. At step 735, the SM 250 executes a second set of instructions to calculate per-pixel values for the fragments based on at least the intermediate values 475. At step 740, the SM 250 determines if fragments of another graphics primitive should be shaded, and, if so, the SM 250 returns to step 722. Otherwise, processing of the graphics primitives for an image is complete and the SM 250 terminates execution of the shader program. The image may be output for display.

Calculating intermediate values at a reduced rate may improve processing performance without degrading image quality by an amount that can be easily perceived. In particular, intermediate values corresponding to low-frequency attributes related to far-field ambient occlusion, soft shadows, ambient lighting approximation, procedurally shaded particle billboards, and ray-marching results for volumetric effects may be calculated at a reduced rate. The intermediate values calculated at a reduced rate may then be combined with high-frequency values according to the pixel shader program to produce the final image.

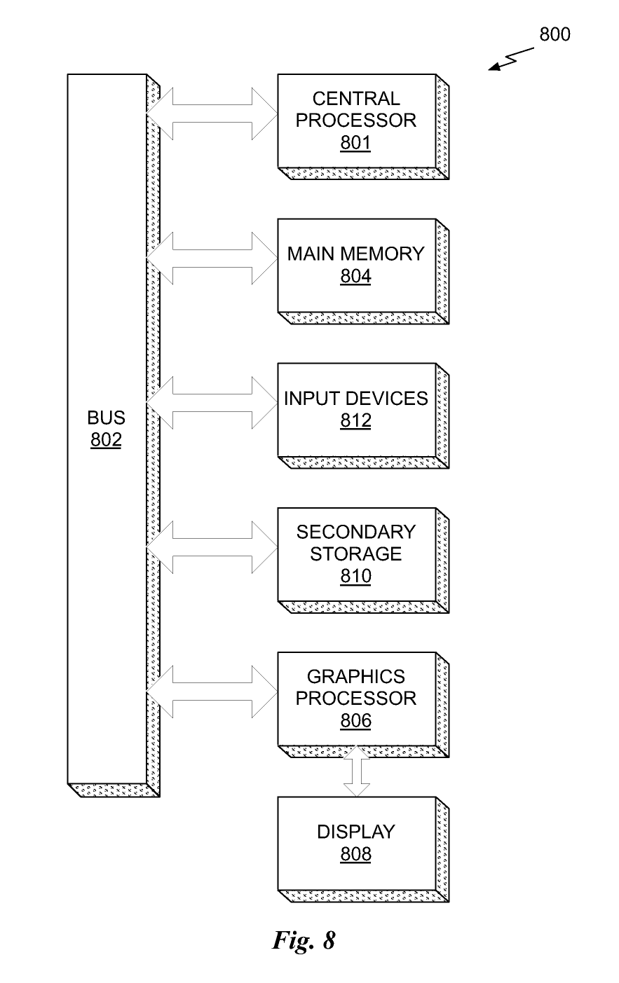

FIG. 8 illustrates an exemplary system 800 in which the various architecture and/or functionality of the various previous embodiments may be implemented. As shown, a system 800 is provided including at least one central processor 801 that is connected to a communication bus 802. The communication bus 802 may be implemented using any suitable protocol, such as PCI (Peripheral Component Interconnect), PCI-Express, AGP (Accelerated Graphics Port), HyperTransport, or any other bus or point-to-point communication protocol(s). The system 800 also includes a main memory 804. Control logic (software) and data are stored in the main memory 804 which may take the form of random access memory (RAM).

The system 800 also includes input devices 812, a graphics processor 806, and a display 808, i.e. a conventional CRT (cathode ray tube), LCD (liquid crystal display), LED (light emitting diode), plasma display or the like. User input may be received from the input devices 812, e.g., keyboard, mouse, touchpad, microphone, and the like. In one embodiment, the graphics processor 806 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 800 may also include a secondary storage 810. The secondary storage 810 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 804 and/or the secondary storage 810. Such computer programs, when executed, enable the system 800 to perform various functions. The memory 804, the storage 810, and/or any other storage are possible examples of computer-readable media.

In one embodiment, the architecture and/or functionality of the various previous figures may be implemented in the context of the central processor 801, the graphics processor 806, an integrated circuit (not shown) that is capable of at least a portion of the capabilities of both the central processor 801 and the graphics processor 806, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 800 may take the form of a desktop computer, laptop computer, server, workstation, game consoles, embedded system, and/or any other type of logic. Still yet, the system 800 may take the form of various other devices including, but not limited to a personal digital assistant (PDA) device, a mobile phone device, a television, etc.

Further, while not shown, the system 800 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
receiving a graphics primitive for processing according to a shader program including a first set of instructions and a second set of instructions;
rasterizing the graphics primitive to produce fragments;
executing, by a processing pipeline, the first set of instructions to calculate multi-pixel intermediate values associated with the fragments, wherein each multi-pixel value corresponds to two or more pixels;
executing, by the processing pipeline, the second set of instructions to calculate per-pixel values associated with the fragments based on at least the multi-pixel intermediate values, wherein each per-pixel value corresponds to one pixel; and
repeating the receiving and executing of the first and second sets of instructions for one or more additional graphics primitives.

2. The method of claim 1, wherein the shader program is annotated to indicate that the first set of instructions should be executed once for multiple pixels to calculate the multi-pixel intermediate values.

3. The method of claim 1, further comprising, after executing the first set of instructions, culling a portion of the graphics primitive based on the multi-pixel intermediate values before executing the second set of instructions.

4. The method of claim 1, wherein a first multi-pixel intermediate value corresponds to more than four pixels and a second multi-pixel intermediate value corresponds to four or fewer pixels.

5. The method of claim 1, further comprising:
determining, based on at least one of the multi-pixel intermediate values, that per-pixel intermediate values should be calculated instead of the multi-pixel intermediate values; and
executing the first set of instructions to calculate the per-pixel intermediate values before executing the second set of instructions.

6. The method of claim 5, further comprising terminating execution of a group of parallel threads that are determining the multi-pixel intermediate values.

7. The method of claim 1, wherein each processing thread in a first set of processing threads is assigned to calculate one multi-pixel intermediate value and each processing thread in a second set of processing threads is assigned to calculate one per-pixel value.

8. The method of claim 1, further comprising determining a number of pixels corresponding to each multi-pixel intermediate value based on a pixel density of a display device.

9. The method of claim 1, wherein the first set of instructions is configured to perform low frequency shading computations.

10. The method of claim 1, wherein the first set of instructions is generated by performing a live variable analysis to identify variables used to calculate the multi-pixel intermediate values.

11. The method of claim 1, further comprising
receiving a second graphics primitive for processing according to a third set of instructions and a fourth set of instructions;
rasterizing the second graphics primitive to produce second fragments;
executing, by the processing pipeline, the third set of instructions to calculate second multi-pixel intermediate values associated with the second fragments, wherein each multi-pixel value corresponds to one pixel;
executing, by the processing pipeline, the fourth set of instructions to calculate per-sample values associated with the second fragments based on at least the second multi-pixel intermediate values, wherein each per-sample value corresponds to a sample location within a pixel.

12. A system comprising:
a memory configured to store a shader program including a first set of instructions and a second set of instructions; and
a processing pipeline that is configured to:
receive a graphics primitive for processing according to the shader program;
rasterize the graphics primitive to produce fragments;
execute the first set of instructions to calculate multi-pixel intermediate values associated with the fragments, wherein each multi-pixel value corresponds to two or more pixels;
execute the second set of instructions to calculate per-pixel values based on at least the multi-pixel intermediate values associated with the fragments based on at least the multi-pixel intermediate values, wherein each per-pixel value corresponds to one pixel; and
repeat the receiving and executing of the first and second sets of instructions for one or more additional graphics primitives.

13. The system of claim 12, wherein the shader program is annotated to indicate that the first set of instructions should be executed once for multiple pixels to calculate the multi-pixel intermediate values.

14. The system of claim 12, wherein the processing pipeline is further configured to cull a portion of the graphics primitive based on the multi-pixel intermediate values after executing the first set of instructions and before executing the second set of instructions.

15. The system of claim 12, wherein a first multi-pixel intermediate value corresponds to more than four pixels and a second multi-pixel intermediate value corresponds to four or fewer pixels.

16. The system of claim 12, wherein the processing pipeline is further configured to:
determine, based on at least one of the multi-pixel intermediate values, that per-pixel intermediate values should be calculated instead of the multi-pixel intermediate values; and
execute the first set of instructions to calculate the per-pixel intermediate values before executing the second set of instructions.

17. The system of claim 12, wherein each processing thread in a first set of processing threads is assigned to calculate one multi-pixel intermediate value and each processing thread in a second set of processing threads is assigned to calculate one per-pixel value.

18. The system of claim 12, wherein the processing pipeline is further configured to determine a number of pixels corresponding to each multi-pixel intermediate value based on a pixel density of a display device.

19. The system of claim 12, wherein the first set of instructions is configured to perform soft shadow calculations.

20. A computer-readable storage medium storing instructions that, when executed by a processor, causes the processor to perform steps comprising:
receiving a graphics primitive for processing according to a shader program including a first set of instructions and a second set of instructions;
rasterizing the graphics primitive to produce fragments;
executing, by a processing pipeline, the first set of instructions to calculate multi-pixel intermediate values associated with the fragments, wherein each multi-pixel value corresponds to two or more pixels;
executing, by the processing pipeline, the second set of instructions to calculate per-pixel values associated with the fragments based on at least the multi-pixel intermediate values, wherein each per-pixel value corresponds to one pixel; and
repeating the receiving and executing of the first and second sets of instructions for one or more additional graphics primitives.
